(19) United States
(12) Patent Application Publication
(10) Pub. No.: US 2001/0001647 A1
(43) Pub. Date: May 24, 2001

(54) EXHAUST GAS PURIFICATION SYSTEM FOR DIESEL MOTORS

(76) Inventors: JURGEN LEYRER, RHEINFELDEN (DE); HARALD KLEIN, BESSENBACH (DE); EGBERT LOX, HANAU (DE); THOMAS KREUZER, KARBEN (DE); THOMAS RIED, BIBLIS-NORDHEIM (DE)

Correspondence Address: BEVERIDGE DEGRANDI WEILACHER & YOUNG, SUITE 800, 1850 M STREET NW, WASHINGTON, DC, 20036

(21) Appl. No.: 09/070,784

(22) Filed: May 1, 1998

(30) Foreign Application Priority Data
May 2, 1997 (DE) 197 18 727.7

(51) Int. Cl. B01D 53/34; B01D 53/94; F01N 3/10

(52) U.S. Cl. 422/180; 422/171; 422/177; 423/215.5

(57) ABSTRACT

An exhaust gas cleaning system for diesel motors made out of two diesel exhaust catalytic converters, arranged in sequence one behind the other, in the form of honeycomb bodies with parallel flow channels, whose wall surfaces are provided with a catalytically active coating. The first upstream catalytic converter possesses a cell density of less than 40 to 80 flow channels per cross-sectional square centimeter, while the cell density of the second catalytic converter situated downstream is larger than that of the first catalytic converter. Through this arrangement, it is possible to select a high cell density that, without connection in line with the low cell density catalytic converter would very quickly lead to a clogging by diesel particles.

### INTRODUCTION AND BACKGROUND

The present invention relates to an exhaust gas purification system for diesel motors.

The exhaust gases of diesel motors is distinguished in many ways from the exhaust gas of gasoline motors. In addition to the pollutant components which are also typical with gasoline motors, such as carbon monoxide, hydrocarbons and nitrogen oxides, diesel exhaust gas also contains so-called diesel particles, which involve an aggregation of soot particles, sulfates and unburned long-chain hydrocarbons, that, along with the sulfates, are responsible for the clustering of the soot particles. The average diameter of the soot particles lies in the range of about 50 to 300 nm. Nevertheless, considerable portions with particle diameters up to 10 μm occur.

In addition to the fact that the diesel exhaust gas contains about 3 to 10% oxygen by volume and is considerably colder than the exhaust gas from gasoline motors (only 100 to 700° C. compared with 300 to 1000° C. in gasoline motors), the large proportion of particles represents a considerable problem in exhaust gas purification.

For the removal of particles from the exhaust gas, mechanical filtering systems were developed that filter the particles out of the exhaust gas stream. With increasing deposition of the particles on the filters, the loss of pressure caused by this is increased, so that the filter periodically must be regenerated by burning off of the particles. In order to facilitate the regeneration, the filters are provided in part with catalytically active layers.

Carbon monoxide and unburned, gaseous hydrocarbons, because of the high oxygen content in the diesel exhaust gas, can relatively easily be converted by so-called diesel oxidation catalysts to carbon dioxide and water. This involves mostly the use of monolithic honeycomb bodies made out of inert material such as, for example, ceramic or metal, that have parallel flow channels for enabling the exhaust gas to freely pass through. The walls of the flow channels are coated with catalytically active layers for the oxidation of carbon monoxide and hydrocarbons. The number of flow channels per cross sectional area of the honeycomb bodies is referred to as cell density. It lies in the range of between 4 and 62 cm⁻² with diesel oxidation catalysts. Above a cell density of 62 cm⁻² the danger increases, with these catalytic converters, that the diesel particles are deposited on the walls of the flow channels and eventually clog them up.

Diesel oxidation catalysts have special catalyst formulations that are optimized such that they specifically oxidize carbon monoxide and hydrocarbons with good degrees of efficiency, but do not, however, also oxidize out the sulfur dioxide and nitrogen oxides likewise present in the exhaust gas. In the case of sulfur dioxide, a further oxidation would lead to the formation of sulfates, that on their part again promote the formation of diesel particles.

Good oxidation catalysts avoid this undesirable oxidation of sulfur dioxide. Moreover, with the use of these catalysts, even a certain reduction of the particle quantities is observed, since the content of the particles of long-chain, condensed hydrocarbons (SOF: soluble organic fraction) is reduced through oxidation on the catalyst. With these catalysts, up til now the exhaust gas limit values for diesel vehicles could be maintained in relation to carbon monoxide, hydrocarbons and particles.

For the reduction of nitrogen oxides in the diesel exhaust gas, special reduction catalysts were developed that were capable of reducing the nitrogen oxides even in the presence of oxygen to elementary nitrogen. The carbon monoxide present in the exhaust gas and the unburned hydrocarbons therefore serve as a reduction medium and are oxidized to carbon dioxide and water, while the nitrogen oxides are reduced to nitrogen. Reduction catalysts are thus also always good oxidation catalysts. The oxidation rates lie at over 80%. The maximum conversion rates for the nitrogen oxides reach about 70%.

However, further restriction of. the exhaust gas limit values for diesel motors makes necessary the improvement of the cited degrees of conversion efficiency for the gaseous pollutants as well as the reduction of the particle emissions.

It is known that the effectiveness of catalytic converters for gasoline motors can be improved through increase of their geometric surface areas. With the aforementioned honeycomb catalytic converters, this means an increase of the cell density. Accordingly, there are honeycomb monoliths in development with cell densities up to 300 cm⁻². Cell densities of up to 100 cm⁻² are already in use in connection with gasoline engines. Their application for the purification of diesel exhaust gases is hindered, however, by the diesel particles. As was already outlined, cell densities of about 60 cm⁻² represent the maximum that could be cleaned with the typical diesel exhaust gases without the danger of a clogging of the honeycomb bodies.

The limit of about 60 cm⁻² is not an absolutely fixed value, but rather depends upon the nature of the particles in the diesel exhaust gas, and with it also the type of diesel motor. Depending upon each specific motor type, this limit can be adjusted upward or downward by about 20±cm⁻².

### SUMMARY OF THE INVENTION

An object of the present invention is therefore to develop with an exhaust purification system for diesel motors which is equipped to use honeycomb catalytic converters with high cell densities for the purification of diesel exhaust gases without the danger of clogging by the diesel particles.

This and other objects of the invention are achieved by an exhaust gas purification system for diesel motors comprising two diesel exhaust catalytic converters, which are designed in the form of honeycomb bodies having a plurality of parallel flow channels whose wall surfaces are provided with a catalytically active purification coating. The exhaust gas purification system is characterized in that the first catalytic converter situated upstream from the second catalytic converter has from less than 40 up to 80 flow channels per cross-sectional square centimeter and the second catalytic converter situated downstream from the first catalytic converter has more flow channels per cross-sectional square centimeter than the first catalytic converter.

Preferably, the first catalytic converter has 4 to 70 flow channels per cross-sectional square centimeter of the honeycomb body, and the second catalytic converter more than 40 to 300.

Through the relatively large cell structure of the first catalyst it is prevented from being clogged up by the particles in the exhaust gas. Through contact of the particles with the catalyst layer, the condensed hydrocarbons sticking to it are in part oxidized. In this way the diameter of the particles is reduced and they can also pass through the second catalytic converter with the higher cell density without the danger of it clogging up. A possible reason for the low clogging incidence after the first catalytic converter could also be the fact that the particles are quasi-dried through the burning of the long-chain chain hydrocarbons condensed on the soot. The dried particles show a lower incidence of clumping and with it a lower incidence of clogging than the “moist” particles.

### BRIEF DESCRIPTION OF DRAWINGS

The present invention will be further understood with reference to the accompanying drawings, wherein:

FIG. 1 is a schematic diagram of a catalytic converter system consisting of a low and high cell density catalytic converter located upstream and downstream, respectively, in the undercarriage area of a vehicle;

FIG. 2 is a schematic drawing of a catalytic converter system consisting of low cell density catalytic converter near the motor and a high cell density catalytic converter away from the motor;

FIG. 3 is a graph of a plot showing the course of the loss of pressure with various catalytic converters; and

FIG. 4 is a bar graph of particle distribution under various catalytic converter systems.

### DETAILED DESCRIPTION OF INVENTION

Appropriate catalysts for the catalytic converter system are diesel oxidation catalysts or reduction catalysts. Both catalyst types can also be combined in the catalytic converter system.

Diesel oxidation catalysts are described, for example, in DE 39 40 758 C2 which is relied on and incorporated herein by reference. Suitable reduction catalysts for the catalytic converter system are disclosed in the patent application DE 196 14 540 which is relied on and incorporated herein by reference.

The catalytic activity of these catalysts is dependent upon temperature. At ambient temperature they are catalytically inactive and allow the pollutants to pass through unhindered. With increasing exhaust gas temperature, the is catalytic activity increases steadily for the conversion of carbon monoxide and hydrocarbons and at the so-called light-off temperature reaches conversion rates of 50%. The light-off temperature can vary for each pollutant. Because of the low exhaust gas temperatures of diesel exhaust, catalysts were developed with light-off temperatures for carbon monoxide of between 100 and 200° C., and for long-chain hydrocarbons of less than 75° C. (DE 196 14 540.6). With increasing exhaust temperatures, the conversion rates of reduction catalysts then increase for nitrogen oxides. They run through a maximum, however, and then fall again close to 0 at high temperatures. Reduction catalysts thus have a so-called temperature window for the conversion of nitrogen oxides. The position of the temperature window is dependent upon the catalyst formulation. There are “high temperature catalysts” with a temperature window between 280 and 400° C. and “low temperature catalysts” with a temperature window between 170 and 300° C.

A preferred embodiment form of the catalytic converter system according to the invention provides for the combination of a “low temperature” reduction catalyst on a large cell honeycomb body with a downstream “high temperature” reduction catalyst on a high cell density honeycomb body. The first catalyst is situated close to the motor in an area of the exhaust system in which the exhaust gas temperature at full load amounts to more than 300° C., and the second catalyst is situated away from the motor in which the exhaust gas temperature at full load lies within the temperature window for the nitrogen oxides reduction of the second catalyst.

This embodiment form has the advantage that the first catalyst, situated close to the motor, is heated up very quickly. It therefore bypasses the temperature window for nitrogen oxide reduction. The exhaust gas temperature quickly reaches values over 300° C., at which the first catalyst essentially has only an oxidizing effect. The high exhaust gas temperature in this area favors the conversion of the long-chain hydrocarbons absorbed on the soot. Because of the low cell density of the first catalyst, the gaseous hydrocarbons and carbon monoxide are not completely converted and arrive at the second catalytic converter together with the unconverted nitrogen oxides. On its way to the second catalytic converter, the exhaust gas cools off. The cooling off can be optimized through selection of the length of the route between the first and second catalytic converters, and possibly through cooling fins situated on the exhaust lines, such that the exhaust gas temperature at the second catalyst falls directly into its temperature window for the reduction of nitrogen oxides, so that the nitrogen oxides carried in the exhaust gas, under accompaniment of the remaining hydrocarbons and carbon monoxide is as a reduction medium, is converted to carbon dioxide, water and nitrogen. The catalytic effect of the second catalytic converter can be optimized through the selection of a high cell density, without the danger of clogging by soot particles.

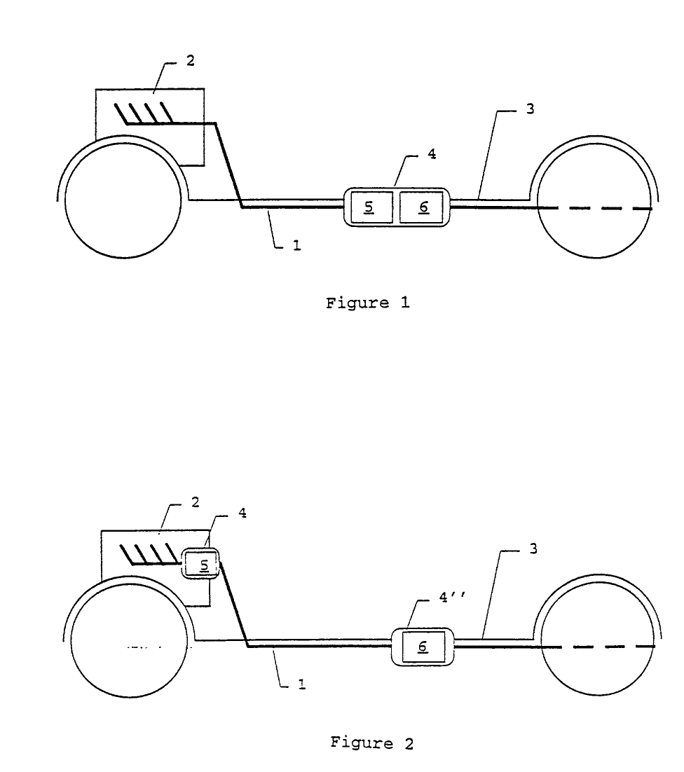

FIG. 1 shows one embodiment of the exhaust gas purification system. The exhaust system 1 of a combustion motor 2 has a converter 4 in the undercarriage area of a vehicle 3. A low cell density catalytic converter 5 and a high cell density catalytic converter 6 are arranged one in front of the other in the common converter housing.

FIG. 2 shows another embodiment of the invention having a separated arrangement of catalytic converter 5 and catalytic converter 6. Catalytic converter 5 is situated in a converter housing 4′ close to the motor, and catalytic converter 6 is situated in converter housing 4″ a distance away from the motor in the undercarriage area of the vehicle.

Table 1 shows the geometric dimensions of the honeycomb bodies made out of cordierite that were used in the following examples.

TABLE 1

| | density | | | wall | |
|---|---|---|---|---|---|
| honeycomb | density | diameter | length | thickness | volume |
| bodies | (cm-2) | (cm) | (cm) | (mm) | (1) |
| Type 1 | 31 | 9.3 | 11.4 | 0.3 | .077 |
| Type 2 | 93 | 9.0 | 11.0 | 0.1 | 0.7 |

### EXAMPLE 1

One honeycomb body each of Type 1 and 2 were coated with a coating as per Example 1 of the patent application DE 196 14 540 relied on for this purpose and incorporated herein by reference. The finished catalytic coating contains platinum as a catalytically active component on an aluminum silicon with 5% by weight of silicon dioxide for thermal stabilization. Along with that, it contains also 5 various zeolites. The weight ratio of the aluminum silicate to the 5 zeolites amounts to 10:1:1:1:1:1. The details of the manufacture of the catalytically active coating material are found in the cited patent application.

The produced catalysts identified as K1 and K2 had the coating data shown in Table 2:

TABLE 2

| | honeycomb | | |
|---|---|---|---|
| catalyst | bodies | coating | loading |
| K1 | Type 1 | 140 g/1 | 1.41 g Pt/1 |
| K2 | Type 2 | 100 g/1 | 1.10 g Pt/1 |

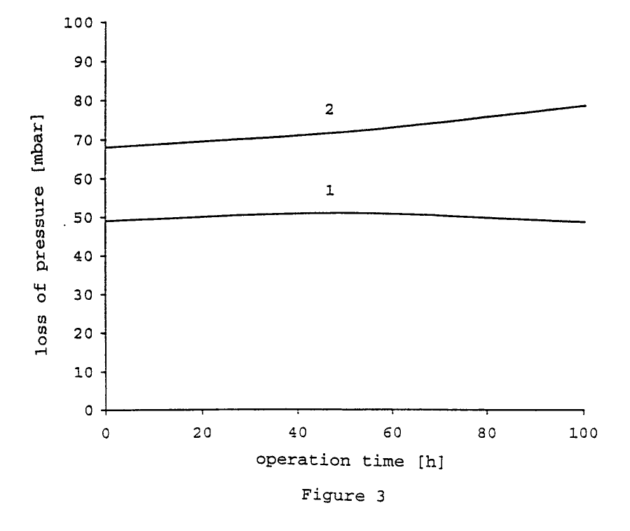

For the demonstration of the clogging incidence of the two catalysts K1 and K2, the course of the pressure loss was plotted as a function of operating time in FIG. 3. For this, catalyst K1 was first installed in the converter housing of the exhaust system of a direct fuel injection diesel motor (displacement 2.0 liter), and the time related course of the loss of pressure was measured at a rotational motor speed of 2000 min⁻¹ and at a turning moment of 50 Nm (Curve 1). The same experiment was repeated with catalyst K2 instead of K1 (Curve 2). Curve 1 shows a nearly constant loss of pressure of catalyst 1 during the measuring time of 100 hours. As per Curve 2, the high cell density catalyst has, by contrast, a progressive increase of the loss of pressure, that would eventually lead to complete clogging.

### EXAMPLE 2

In the converter housing of the exhaust system, 3 different catalyst systems were constructed, one after the other, out of each of the 2 honeycomb bodies with various coating conditions, and the particle distribution behind the converter was measured. The three catalyst systems had the characteristics specified in Table 3:

TABLE 3

| System | Honeycomb body 1 | Honeycomb body 2 |
|---|---|---|
| System 1 | W1 | W2 |
| System 2 | K1 | W2 |
| System 3 | K1 | K2 |

W1, W2: uncoated honeycomb bodies of Type 1 or 2
K1: catalyst K1 of Example 1
K2: catalyst K2 of Example 2

The particle distributions were determined with the low pressure impactor LPI 25 of Hauke. The device is used for the determination of particle sizes of an aerosol (here the diesel exhaust gas) and works according to the so-called inertial sensing process. In this way the soot particles of the exhaust gas are separated in sequential stages according to particle size and deposited on deflector plates. In one such deposition stage, the exhaust, together with the soot particles suspended in it, is accelerated through a nozzle and conducted onto a deflector plate perpendicular to it. The heaviest particles are deposited on the plate as a consequence of their inertia, while the gas flow with the lighter particles is reversed and is conducted into the next deposition stage. The deposited quantities of the particle fractions are determined by difference in the weighing of the deflector plates before and after the measurement. The measurements were taken over an entire test cycle according to MVEG-A.

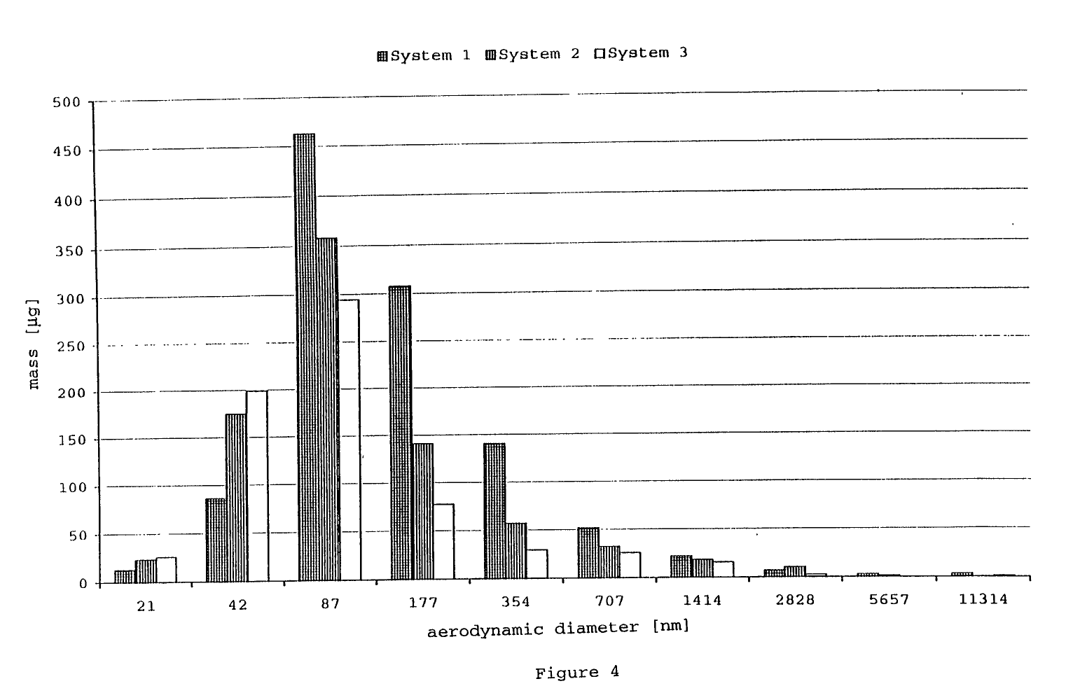

First the “crude emission” of the diesel motor was determined after flowing through the two uncoated honeycomb bodies W1 and W2 (System 1). Next the catalyst systems 2 and 3 were examined. The particle distributions are represented in FIG. 4. In FIG. 4 the quantity of soot particles deposited on the deflector plates was plotted across the aerodynamic diameter involved.

One recognizes in relation to FIG. 4, that the particle emission through System 2 is substantially reduced in comparison to the catalytically inactive System 1. The cause of this is the catalytic oxidation of the long-chain hydrocarbons condensed on the diesel particles. Therefore the focus of the particle distribution shifts to smaller particle diameters. Above an aerodynamic diameter of about 80 nm, the deposited particle mass, with application of the catalytically coated honeycomb body, is smaller than with uncoated honeycomb bodies. Under 80 nm these ratios are reversed. System 3 with two catalytically coated honeycomb bodies, compared to System 2 brings a further reduction of the particle emission.

The overall particle emission following the uncoated honeycomb bodies (System 1) amounted to 1100 μg. This value was reduced to 820 μg by System 2. Following System 3 only a total particle emission of 670 μg was measured.

Further modifications and variations of the foregoing will be apparent to those skilled in the art and are intended to be encompassed by the claims.

German priority application 197 18 727.7 is relied on and incorporated herein by reference.

We claim:

1. An exhaust gas purification system for diesel motors comprising two diesel exhaust catalytic converters, arranged in sequence one behind the other, each being in the form of a honeycomb body with a plurality of parallel flow channels, whose wall surfaces are provided with a catalytically active coating, wherein a first upstream catalytic converter has a cell density of less than 40 to 80 flow channels per cross-sectional square centimeter, and the cell density of the second catalytic converter situated downstream is larger than that of the first catalytic converter.

2. The exhaust gas purification system for diesel motors according to claim 1, the first catalytic converter has 4 to 70 flow channels, per cross-sectional centimeter, and the second has between 40 and 300.

3. The exhaust gas purification system for diesel motors according to claim 2, wherein each catalytic converter is coated on the interior flow channel walls with a diesel oxidation catalyst.

4. The exhaust gas purification system for diesel motors according to claim 2, wherein each catalytic converter is coated on the interior flow channels walls with a diesel reduction catalyst.

5. The exhaust gas purification system for diesel motors according to claim 4, wherein the first catalytic converter, is in an area of the exhaust gas system, in which the exhaust gas temperature under full load amounts to more than 300° C. and the second catalytic converter, away from the motor, is situated in an area in which the exhaust gas at full load lies within the temperature window for the nitrogen oxide reduction of this second catalyst.

6. A process for purifying diesel exhaust gas comprising contacting exhaust gas from a diesel engine with the catalyst system of claim 1.

7. An automobile equipped with a diesel engine having the exhaust gas purification system according to claim 1.
